(19) United States
(12) Patent Application Publication
(10) Pub. No.: US 2016/0019105 A1
(43) Pub. Date: Jan. 21, 2016

(54) COMPUTER EMBEDDED APPARATUS, RECORDING MEDIUM AND COMPUTER EMBEDDED APPARATUS TEST SYSTEM

(71) Applicants: Machiko MIKAMI, Tokyo (JP); Yukinari Toyota, Tokyo (JP)

(72) Inventors: Machiko MIKAMI, Tokyo (JP); Yukinari Toyota, Tokyo (JP)

(21) Appl. No.: 14/789,237

(22) Filed: Jul. 1, 2015

(30) Foreign Application Priority Data
Jul. 16, 2014 (JP) 2014-145621
Jul. 16, 2014 (JP) 2014-145622

(51) Int. Cl. G06F 9/54

(52) U.S. Cl. CPC G06F 9/546; G06F 9/542

(57) ABSTRACT

There is provided a computer embedded apparatus comprising: a process control unit configured with a plurality of software layers wherein each of the layers provides a service to an upper layer and each of the layers includes, a message processing unit configured to control a sequence of messages input to or output from the layer.

### BACKGROUND OF THE INVENTION

1. Field of the Invention

Present technology relates to a control technology for a computer embedded apparatus such as an image forming apparatus.

2. Description of the Related Art

A computer embedded apparatus such as an image forming apparatus requires complicated and precise control of hardware such as a printer engine, or scanner engine.

Conventionally, such computer embedded apparatuses are usually controlled, by running an open source universal OS (Operating System) on single processor (single core) computer hardware (for example, Japanese Laid-open Patent Publication No. 2002-84383).

Recently, multiprocessor (multi core) computer hardware is mainly used instead of single processor computer hardware. Then, the open source universal OS began to support the multiprocessor computer hardware.

An OS supporting the multiprocessor computer hardware performs multithreading operations for allocating executable codes to the respective processors according to a scheduling function of the OS. In order to avoid failures, the OS or related software needs to be tuned.

However, even though the OS or related software has been tuned so as to be operated without such failures, the failures may occur again upon the OS being upgraded to the latest version. Thus, such tuning has to be done every time the OS is upgraded, which causes the workload to be increased.

Also, when using the open source universal OS, different from a case of using an OS provided by a well-known manufacturer, a developer of the computer embedded apparatus has to handle all of such failures since the providing source of the open source universal OS is free of responsibility to correct failures.

Various tests are required to develop application programs using functions of the computer embedded apparatus or to develop the computer embedded apparatus itself. Conventionally, the tests have been conducted by using actual apparatuses, generally. Therefore, the test is hardly conducted when the actual apparatus is not available.

Also, there are some cases in which tests using the computer embedded apparatuses having been delivered to customers in actual working environments are required. However, visiting various customers to test the computer embedded apparatus is not realistic.

### RELATED ART DOCUMENT

### Patent Document

### [Patent Document 1]: Japanese Laid-open Patent Publication No. 2002-84383

### SUMMARY OF THE INVENTION

An object of disclosure of the present technology is to achieve the complicating and precise controls of computer embedded apparatuses regardless of the OS environment.

The following configuration is adopted to achieve the aforementioned object.

In one aspect of the embodiment, there is provided a computer embedded apparatus comprising: a process control unit configured with a plurality of software layers wherein each of the layers provides a service to an upper layer and each of the layers includes a message processing unit configured to control a sequence of messages input to or output from the layer.

Other objects, features and advantages of the present invention will become more apparent from the following detailed description when read in conjunction with the accompanying drawings.

### BRIEF DESCRIPTION OF THE DRAWINGS

FIG. 1 is a diagram for illustrating a functional configuration of an image forming apparatus.

FIG. 2 is a diagram for illustrating a functional configuration of a message processing unit.

FIG. 3 is a flowchart for illustrating an example of a process performed by the message processing unit.

FIG. 4 is a diagram for illustrating an example functional configuration for testing an actual apparatus from an external apparatus.

FIG. 5 is a diagram for illustrating an example functional configuration for conducting a test without an actual apparatus.

FIG. 6 is a diagram for illustrating another example functional configuration for conducting a test without an actual apparatus.

FIG. 7 is a block diagram for illustrating an example configuration of respective computers included in the image forming apparatus, a server apparatus and an information processing apparatus.

FIG. 8 is a diagram for illustrating an example configuration of a device emulator and an example of connections with other parts.

FIG. 9 is a sequence diagram for illustrating an example test.

### DETAILED DESCRIPTION OF THE PREFERRED EMBODIMENTS

Herein below, embodiments will be described with reference to accompanying drawings. Although, in the description, an image forming apparatus such as a multifunction peripheral is exemplified, the present technology can be applied to other apparatuses including hardware not included in a common information processing apparatus.

<Image Forming Apparatus>

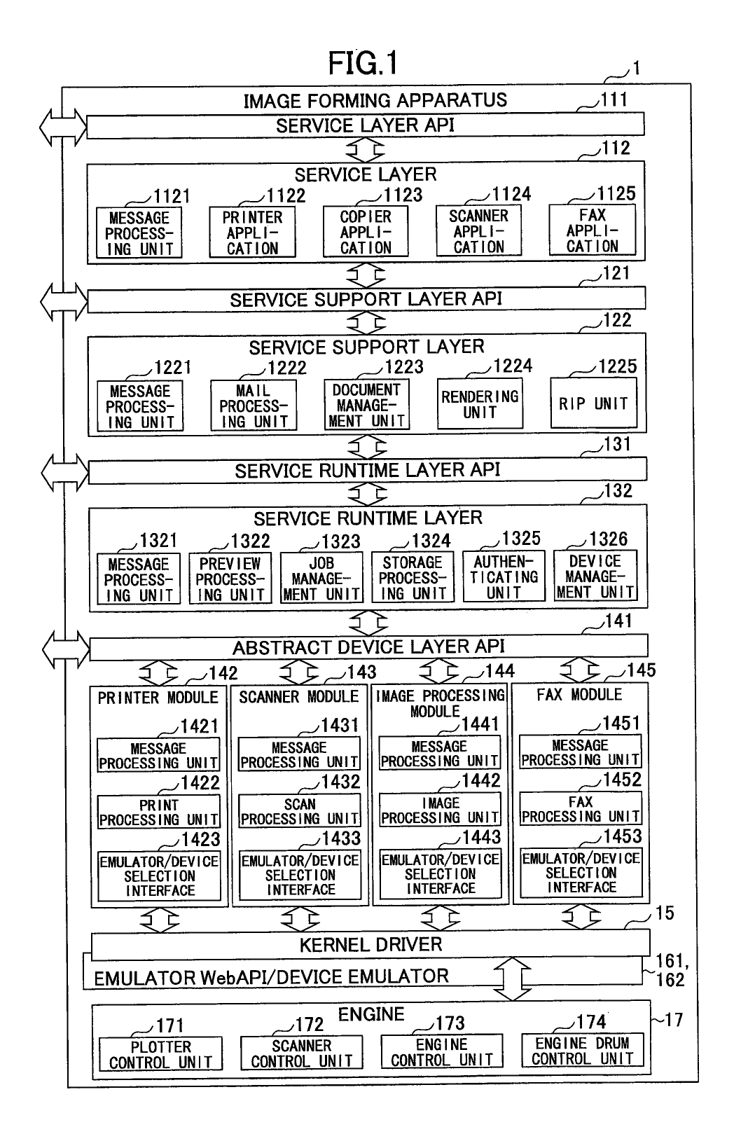

FIG. 1 is a diagram for illustrating a functional configuration of an image forming apparatus 1. In FIG. 1, the image forming apparatus 1 includes a service layer 112, a service support layer 122, a service runtime layer 132, and modules 142, 143, 144 and 145 included in an abstract device layer. The service layer 112 is a layer for providing services such as printing, copying, scanning, faxing, and the like. The service support layer 122 is a layer for providing a common function to achieve the services. The service runtime layer 132 is a layer for providing functions of device management, service (job) management, authentication, storage, and the like. The abstract device layer is a layer for providing interfaces for abstracted devices such as a printer, a scanner, a fax machine, and the like.

A service layer API 111 is disposed corresponding to the service layer 112. The service layer API 111 includes a service layer WebAPI 1111 achieved by HTTP (HyperText Transfer Protocol) REST (REpresentational State Transfer) or the like, and a service layer inter-process communication API 1112 achieved by inter-process communication of Unix Domain Socket or the like.

A service support layer API 121 is disposed corresponding to the service support layer 122. The service support layer API 121 includes a service support layer WebAPI 1211 achieved by HTTP REST or the like, and a service support layer inter-process communication API 1212 achieved by inter-process communication of Unix Domain Socket or the like.

A service runtime layer API 131 is disposed corresponding to the service runtime layer 132. The service runtime layer API 131 includes a service runtime layer WebAPI 1311 achieved by HTTP REST or the like, and a service runtime layer inter-process communication API 1312 achieved by inter-process communication of Unix Domain Socket or the like.

An abstract device layer API 141 is disposed corresponding to the abstract device layer. The abstract device layer API 141 includes an abstract device layer WebAPI 1411 achieved by HTTP REST or the like, and an abstract device layer inter-process communication API 1412 achieved by inter-process communication of Unix Domain Socket or the like.

A message processing unit 1121, a printer application 1122, a copier application 1123, a scanner application 1124, and a fax application 1125 are included in the service layer 112. The message processing unit 1121 has a function to perform processes of three forms of messages (command, response and notification) in the service layer 112. An internal configuration thereof and details of the processes are described below. The printer application 1122 is an application program for providing printing service. The copier application 1123 is an application program for providing copying service. Scanner application 1124 is an application program for providing scanning service. The fax application 1125 is an application program for providing fax service.

A message processing unit 1221, a mail processing unit 1222, a document management unit 1223, a rendering unit 1224 and a RIP unit 1225 are included in the service support layer 122. The message processing unit 1221 has a function to perform processes of three forms of messages (command, response and notification) in the service support layer 122. An internal configuration thereof and details of the processes are described below. The mail processing unit 1222 provides a function for sending and receiving mail. The document management unit 1223 provides a function for managing and storing documents. The rendering unit 1224 provides a function for rendering images. The RIP unit 1225 provides a function for performing RIP (Raster Image Processing).

A message processing unit 1321, a preview processing unit 1322, a job management unit 1323, a storage processing unit 1324, an authenticating unit 1325, and a device management unit 1326 are included in the service runtime layer 132. The message processing unit 1321 has a function to perform processes of three forms of messages (command, response and notification) in the service runtime layer 132. An internal configuration thereof and details of the processes are described below. The preview processing unit 1322 provides a function for generating preview images. The job management unit 1323 provides a function for managing jobs. The storage processing unit 1324 provides a function of storage management. The authenticating unit 1325 provides a function of authentication. The device management unit 1326 provides a function of device management.

The abstract device layer constitutes the core of controller architecture of the image forming apparatus 1. The abstract device layer is the lowest layer in the controller architecture of the multifunction peripheral, including modules of a printer, a scanner, a copier, a fax, and the like. The main role thereof is to provide an abstract API for hiding control methods of connected hardware (devices). For example, as for a scanner, connecting method and control method thereof vary according to respective devices. Such actual control methods of the devices are not reflected in the API, while the abstract device layer provides a more highly abstracted API for using the devices. Meanwhile, the abstract device layer is required to not limit a function of the device when the upper layer client uses the device. For example, as for the scanner, changing parameters for respective pages of a document is required, so that a service can be provided, where the scanning method of the second page of the document can be changed by analyzing the scanned first page. As a consequence, not an API for scanning the document all together but an API for scanning the document page by page is required in the abstract device layer.

The API of the abstract device layer also achieves support of fault recovery. Generally, a client of the abstract device layer is not required to know a concrete method for recovering from a fault (for example, paper jam in a printer) occurring in the device. Otherwise, the client needs to study fault recovery methods for respective devices. However, actually, the fault recovery method has to be shown to a user. For example, a process for eliminating the jammed paper has to be shown. The abstract device layer provides the client of the API to show the user the fault recovery process, thereby enabling the fault recovery process of the respective devices to be known only by the abstract device layer. Generally, the abstract device layer provides the API for not only meticulously controlling the devices but also hiding actual control methods of the devices.

The printer module 142 provides a function of an abstracted printer engine (plotter engine). Basically, the printer module 142 provides a function for printing page by page. However, the printer module 142 is responsible for controlling the printer engine so as to maximize its performance in a case where the client issues plenty of requests for printing.

The scanner module 143 provides a function of an abstracted scanner engine. Basically, the scanner module 143 provides a function for scanning the document page by page. The scanner module 143 is responsible for controlling ADF (Auto Document Feeder) or the like to operate at top speed.

The image processing module 144 provides a function of abstracted imaging process. Although, in FIG. 1, the image processing module 144 is described as logically one module, it performs the imaging process not only separately but also in conjunction with other modules. For example, a case where a scanned document is compressed by a JPEG compression is described. Hardware for compressing by the JPEG compression as well as scanning may be included in a connected scanner. Or the connected scanner may include software for compressing by the JPEG compression. The client should not be required to know which configuration the scanner has. And the client should be allowed to instruct to scan and compress regardless of the configurations. In this case, the client requests the image processing module 144 to perform the JPEG compression. The image processing module 144 responds to a descriptor indicating the requested process. The client designates the descriptor as one of scanning parameters, thereby requests the scanner module 143 to compress the scanned document. The client does not need to know whether the actual JPEG compression is performed by hardware or software. Meanwhile, the image processing module 144 can separately perform the imaging process. For example, the image processing module 144 can scan a document having a plurality of pages stored in a disk and convert the scanned document into a document having thumbnail images or into a document in which the images of respective pages are rotated.

The fax module 145 provides a function of abstracted fax transmitting/receiving.

Additionally, the modules 142, 143, 144, and 145 manage utilization rights of respective hardware resources. For example, in a case where only one scanner is connected with the scanner module 143, only one client is allowed to use the hardware resource. Therefore, the client needs to acquire the utilization rights before using the hardware resource. Meanwhile, some devices do not require to limit the number of clients logically using them simultaneously. For example, the fax module 145 accepts transmission instructions from a plurality of users, because a delay (transmission failure and retransmission) is allowed in fax transmission. Regardless of types of the device, the client needs to perform a process of requesting the hardware resource, using the hardware resource, and releasing the hardware resource, in order to use the hardware resource. Here, small equipment included in the device is not included in the hardware resource. For example, as for the printer module 142, although the printer includes paper trays and a finisher such as a stapler, such equipment is not required to be requested as the hardware resource. For example, a scanner or a printer is required to be requested as the hardware resource.

The printer module 142 includes a message processing unit 1421, a print processing unit 1422 and an emulator/device selection interface 1423. The message processing unit 1421 has a function to perform processes of three forms of messages (command, response and notification) in the printer module 142. An internal configuration thereof and details of the processes are described below. The print processing unit 1422 controls a printing process. The emulator/device selection interface 1423 provides a function for selecting a device emulator 162 or a kernel driver 15 according to the types of actual device or non-actual device.

The scanner module 143 includes a message processing unit 1431, a scan processing unit 1432 and an emulator/device selection interface 1433. The message processing unit 1431 has a function to perform processes of three forms of messages (command, response and notification) in the printer module 143. An internal configuration thereof and details of the processes are described below. The scan processing unit 1432 controls a scanning process. The emulator/device selection interface 1433 provides a function for selecting a device emulator 162 or a kernel driver 15 according to the types of actual device or non-actual device.

The image processing module 144 includes a message processing unit 1441, an image processing unit 1442 and an emulator/device selection interface 1443. The message processing unit 1441 has a function to perform processes of three forms of messages (command, response and notification) in the printer module 144. An internal configuration thereof and details of the processes are described below. The image processing unit 1442 controls an imaging process. The emulator/device selection interface 1443 provides a function for selecting a device emulator 162 or a kernel driver 15 according to the types of actual device or non-actual device.

The fax module 145 includes a message processing unit 1451, a fax processing unit 1452 and an emulator/device selection interface 1453. The message processing unit 1451 has a function to perform processes of three forms of messages (command, response and notification) in the printer module 145. An internal configuration thereof and details of the processes are described below. The fax processing unit 1452 controls a fax transmitting/receiving process. The emulator/device selection interface 1453 provides a function for selecting a device emulator 162 or a kernel driver 15 according to the types of actual device or non-actual device.

Below the modules 142, 143, 144 and 145 which constitute the abstract device layer, the kernel driver 15, an emulator WebAPI 161, the device emulator 162 and an engine 17 are disposed. The kernel driver 15 includes a device driver for controlling the engine 17 in the actual image forming apparatus. The device emulator 162 has a function for emulating processes of the engine 17 in the actual image forming apparatus (for example, emulating signals of processes to be tested, while physical processes such as printing on a paper are not emulated). The emulator WebAPI 161 is an API achieved by HTTP REST or the like for conducting direct tests on the device emulator 162. Additionally, when the test is conducted on the actual image forming apparatus, the emulator WebAPI 161 and the device emulator 162 are not activated. Therefore they seem unnecessary to be disposed in the image forming apparatus 1. However, as described below, by having the same software configuration as a virtual image forming apparatus achieved by performing programs on an information processing apparatus such as PC (Personal Computer) or server, the software can be easily managed in view of unity of the software package. The emulator WebAPI 161 and the device emulator 162 can be omitted in the actual image forming apparatus 1 when such advantage (unity of software package) is not required.

The engine 17 includes a plotter control unit 171, a scanner control unit 172, an engine control unit 173 and an engine drum control unit 174. The plotter control unit 171 controls a plotter. The scanner control unit 172 controls a scanner. The engine control unit 173 controls the engine hardware. The engine drum control unit 174 controls an engine drum (one engine drum for monochrome scanning, four engine drums for color scanning).

<Message Processing Unit>

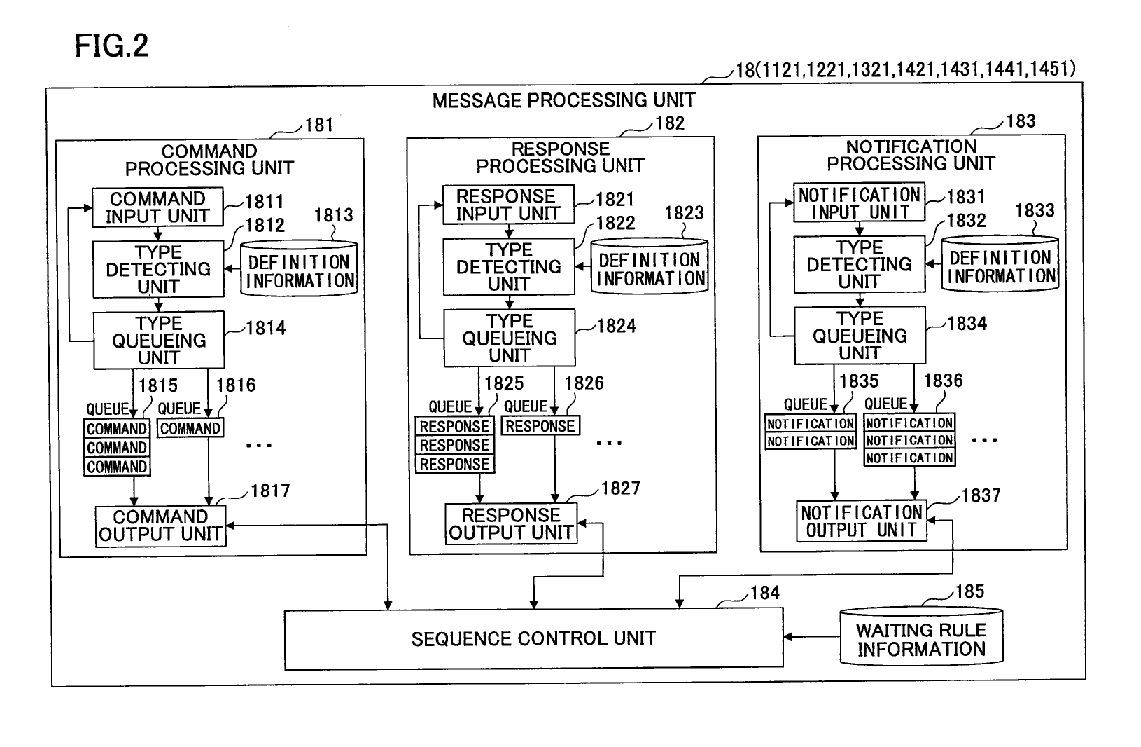

FIG. 2 is a diagram for illustrating a functional configuration of the message processing unit 18 (1121, 1221, 1321, 1421, 1431, 1441 and 1451). In FIG. 2, the message processing unit 18 includes a command processing unit 181, a response processing unit 182, a notification processing unit 183 and a sequence control unit 184. The sequence control unit 184 refers to waiting rule information 185 when performing the processes.

The command processing unit 181 includes a command input unit 1811, a type detecting unit 1812, a type queueing unit 1814 and a command output unit 1817. The command input unit 1811 has a function for inputting a command sent to own layer or own module through the API. The type detecting unit 1812 has a function for detecting types of the commands input by the command input unit 1811 with reference to definition information 1813. The type queueing unit 1814 has a function for queueing the commands whose types are detected by the type detecting unit 1812 in queues 1815, 1816, etc., corresponding to the types of the commands. Additionally, the type queueing unit 1814 stops inputting subsequent commands when the corresponding queue is full. A depth of the queue is set according to the type. For example, the depth of the queue corresponding to a type of command is set to be “1”, which shall be performed without waiting. The command output unit 1817 has a function for retrieving the commands from queues 1815, 1816, etc., under control of the sequence control unit 184 controlling a sequence relation of the command, the response and the notification, thereby outputting the retrieved commands to respective units.

The response processing unit 182 includes a response input unit 1821, a type detecting unit 1822, a type queueing unit 1824 and a response output unit 1827. The response input unit 1821 has a function for inputting responses sent from the respective units. The type detecting unit 1822 has a function for detecting types of the responses input by the response input unit 1821 with reference to definition information 1823. The type queueing unit 1824 has a function for queueing the responses whose types are detected by the type detecting unit 1822 in queues 1825, 1826, etc., corresponding to the types of the responses. The response output unit 1827 has a function for retrieving the responses from queues 1825, 1826, etc., under control of the sequence control unit 184 controlling a sequence relation of the command, the response and the notification, thereby outputting the retrieved responses to command sources.

The notification processing unit 183 includes a notification input unit 1831, a type detecting unit 1832, a type queueing unit 1834 and a notification output unit 1837. The notification input unit 1831 has a function for inputting notifications sent from the respective units. The type detecting unit 1832 has a function for detecting types of the notifications input by the notification input unit 1831 with reference to definition information 1833. The type queueing unit 1834 has a function for queueing the notifications whose types are detected by the type detecting unit 1832 in queues 1835, 1836, etc., corresponding to the types of the notifications. The notification output unit 1837 has a function for retrieving the notifications from the queues 1835, 1836, etc., under control of the sequence control unit 184 controlling a sequence relation of the command, the response and the notification, thereby outputting the retrieved notifications to respective destinations.

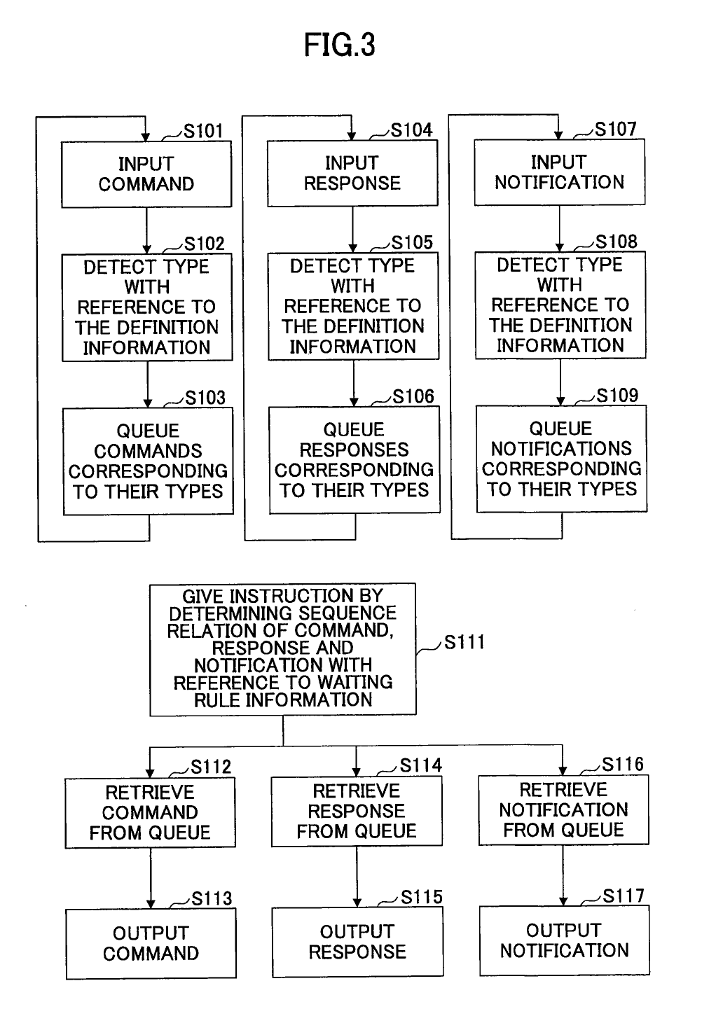

FIG. 3 is a flowchart for illustrating an example of a process performed by the message processing unit 18. In FIG. 3, the command input unit 1811 of the command processing unit 181 inputs the command sent to own module through the API (step S101). The type detecting unit 1812 detects the type of the command input by the command input unit 1811 with reference to the definition information 1813 (step S102). The type queueing unit 1814 queues the commands whose types are detected by the type detecting unit 1812 in the queues 1815, 1816, etc., corresponding to the type of the command (step S103).

The response input unit 1821 of the response processing unit 182 inputs the responses sent from the respective units (step S104). The type detecting unit 1822 detects types of the responses input by the response input unit 1821 with reference to definition information 1823 (step S105). The type queueing unit 1824 queues the responses whose types are detected by the type detecting unit 1822 in the queues 1825, 1826, etc., corresponding to the type of the response (step S106).

The notification input unit 1831 of the notification processing unit 183 inputs notifications sent from the respective units (step S107). The type detecting unit 1832 detects the types of the notifications input by the notification input unit 1831 with reference to definition information 1833 (step S108). The type queueing unit 1834 queues the notifications whose types are detected by the type detecting unit 1832 in the queues 1835, 1836, etc., corresponding to the type of the notification (step S109).

Meanwhile, the sequence control unit 184 gives an instruction by determining the sequence relation of the command, the response and the notification with reference to the waiting rule information 185 (step S111). When receiving the instruction from the sequence control unit 184, the command output unit 1817 of the command processing unit 181 retrieves the commands from the queues 1815, 1816, etc., (step S112), thereby outputting the retrieved command to respective units (step S113).

When receiving the instruction from the sequence control unit 184, the response output unit 1827 of the response processing unit 182 retrieves the responses from the queues 1825, 1826, etc., (step S114), thereby outputting the retrieved responses to the command source (step S115).

When receiving the instruction from the sequence control unit 184, the notification output unit 1837 of the notification processing unit 183 retrieves the notifications from the queues 1835, 1836, etc., (step S116), thereby outputting the retrieved notifications to the destinations (step S117).

In the following, the messages handled by the respective message processing units 1421, 1431, 1441 and 1451 of the modules of 142, 143, 144 and 145 in the abstract device layer will be described in detail.

The API of the client with respect to the abstract device layer is formed by the three forms of messages which are the command, the response, and the notification. The command is used for giving instruction from the client to the abstract device layer. Some of the commands are to be performed in sequence while the others are to be performed preferentially. For example, “command for canceling the issued command” and the like are included in the latter. The client can issue the commands one after another without waiting for the responses thereof.

The responses are from the abstract device layer to the client corresponding to the respective commands. The notification is used for reporting from the abstract device modules some sort of events occurring in the abstract device layer. Some of the notifications are to be sent autonomously from the abstract device layer while the others are to be sent in response to performance of the commands. The latter is referred to as “Event” and is sent to only the client which has issued the corresponding command. The former is sent to all the clients connected logically. Here, “logically” means that the clients are not always connected physically. In practical implementation, the clients may be connected by TCP (Transmission Control Protocol) or the like. “Event” can be distinguished from other notifications by determining whether a message name has “EVENT” in the tail thereof.

The responses and the notifications are asynchronously sent to the clients. The abstract device layer uses a complete asynchronous message communication method since time for completing the process is essentially required. For example, when designing by using RPC (Remote Procedure Call) or the like, assuming that time is required to receive the response, Active Object (or Future) pattern is generally adopted. However, in such case, so called multithread programing is required which causes the design and implementation to be difficult. By comparison, constructing a library for supporting client programing based on the asynchronous message communication method is not difficult.

The commands are divided into basic commands and specific commands. The basic command is supported by every module. Meanings of the respective commands are common in most of the modules. The specific command is unique to the module. The commands can be also divided into a type of command to be performed in sequence after being queued and a type of command to be performed promptly without being queued.

The messages of the command, the response and the notification respectively have a sequence number as a common parameter. When issuing a command, the client has to give the sequence number (an integer not less than one) so that the sequence number is unique in the client and monotonically increases. For example, the sequence number is a 64-bit integer. By using the 64-bit integer, the sequence number does not return to the same number when it is given to the respective commands increasing it one by one. The sequence number given to the response is the same as that of the corresponding command. The sequence number given to the notification is always “0”.

The basic commands include:

ENABLE/DISABLE;

SHUTDOWN;

LOCK-DEVICE/UNLOCK-DEVICE;

START-JOB/END-JOB;

ABORT-COMMAND;

START-FAULT-RECOVERY/END-FAULT-RECOVERY; and

ATTACH-SHARED-MEMORY/DETACH-SHARED-MEMORY.

The command “ENABLE” is for instructing to start operation of the abstract device module. Here, “to start operation” means to permit sending various notifications. The respective modules perform initialization of required devices when activated. As a consequence of the initialization, states of the apparatuses (devices) indicating whether the apparatuses (devices) can be used or cannot be used because of some sort of fault are already known. However, notifications of such states shall be sent when the clients are ready to receive notifications. Therefore, the command “ENABLE” is used. In a case where the fault has occurred in the apparatuses (devices) when the command “ENABLE” is received, the notification “FAULTED” is sent before sending the response “COMPLETED” corresponding to the command.

The command “DISABLE” is a command sent before finishing a system to stop sending the notifications after issuing it. Additionally, after issuing the command “DISABLE”, the command “SHUTDOWN” becomes acceptable as well as the command “ENABLE”.

The command “SHUTDOWN” is an instruction to finish running programs, which can be issued only when the abstract device module is not enabled for giving the abstract module. The module is finished after sending the response corresponding to the command “SHUTDOWN”.

The command “LOCK-DEVICE” is for acquiring the utilization right of the device. The command “UNLOCK-DEVICE” is for releasing the utilization right of the device. When there is only one client capable of using the device, multiple locking of the device is not allowed. The fax module or the like may be multiple-locked. Although, one engine such as a scanner or printer is usually connected with a multifunction peripheral, a case where a plurality of the engines are connected with a multifunction peripheral is taken into account in the present description. Meanwhile, even in a case where only one engine is connected with a multifunction peripheral, the command “LOCK-DEVICE” shall be issued from upper layer so as to assure that only one client is allowed access at a time. A tray, a finisher, etc., included in one printer are not to be locked. They shall be managed by the abstract device layer.

The command “ABORT-COMMAND” is for cancelling the issued command. By using this command, an aforementioned job may be entirely canceled. The command to be canceled is designated by the sequence number of the command.

The command “START-FAULT-RECOVERY” is for instructing to send the notification “FAULT-RECOVERY-INSTRUCTION”. Generally, the faults are reported by the notifications. However, the notification for instructing how to recover from the fault is not send autonomously. Even if the fault has not occurred when the command “START-FAULT-RECOVERY” is issued, the notification “FAULT-RECOVERY-INSTRUCTION” will be sent when the fault occurs. The command “END_FAULT_RECOVERY” is used for preventing such notification.

The command “ATTACH-SHARED-MEMORY” and the command “DETACH-SHARED-MEMORY” are for attaching and detaching a shared memory used for exchanging the images between the upper layer and the lower layer. In the command “ATTACH-SHARED-MEMORY”, a parameter indicating key and size of the shared memory is given. In the command “DETACH-SHARED-MEMORY”, a parameter indicating key of the shared memory is given.

The command “REGISTER-EXEC-PARAMS” and the command “UNREGISTER-EXEC-PARAMS” are for registering and deleting a set of operational mode parameters (operational conditions) set for the respective modules (the printer module, the scanner module, the image processing module and the fax module) managed by the abstract device layer.

Basic responses to the respective commands include:

COMPLETED;

ABORTED;

ILLEGAL-PARAMETER-ERROR;

ILLEGAL-STATE-ERROR; and

NO-SUCH-COMMAND-ERROR.

The aforementioned responses also correspond to the specific commands.

The response “COMPLETED” is for indicating completion of the command. Additional parameters may be given to the responses.

The response “ABORTED” is for indicating aborting of the command. The aforementioned command is divided into a type of command which is aborted only by the command “ABORT-COMMAND” and a type of command which is aborted autonomously. For example, when the command “LOCK-DEVICE” is issued, the response “ABORTED” is sent and the reason thereof is indicated by the additional parameters in a case where the device cannot be locked. In a case where the retransmission number exceeds the predetermined number in the fax module or the like, the response “ABORTED” is sent and exceeding the predetermined retransmission number is indicated by the additional parameters.

The response “ILLEGAL-PARAMETER-ERROR” is for indicating invalid parameter value of the command or failure of required parameter setting. The response “ILLEGAL-PARAMETER-ERROR” has a parameter, for showing additional information, indicating the concerned parameter.

The response “ILLEGAL-STATE-ERROR” is for indicating that the command is issued in incorrect sequence or in incorrect state.

The response “NO-SUCH-COMMAND-ERROR” is for indicating that the command is not supported.

Basic notifications commonly used in the respective modules include:

ENABLED/DISABLED;

WARMING-UP/READY;

DEVICE-LOCKED/DEVICE-UNLOCKED;

FAULTED/FAULT-CLEARED;

FAULT-RECOVERY-INSTRUCTION; and STATUS.

The notification “ENABLED” and the notification “DISABLED” are respectively for notifying change of the state according to the command “ENABLE” and the command “DISABLE”. These notifications are to be sent before the responses corresponding to the commands. For example, when the command “ENABLE” is accepted, the notification “ENABLED” is sent, and then the response “COMPLETED” is sent corresponding to the command “ENABLE”. In a case where some sort of fault has occurred when the command “ENABLE” is accepted, the notification “FAULTED” is sent before sending the response “COMPLETED”.

The notification “WARMING-UP” and the notification “READY” are for notifying that the connected device can be used. Meanwhile, in a case where the fault occurs, the notification “FAULTED” is sent instead. Also, when all the faults are recovered, the notification “READY” is sent. In a case where a fault does not occur and the device is being warmed up, the notification “WARMING-UP” is sent instead of the notification “READY”.

The notification “DEVICE-LOCKED” and the notification “DEVICE-UNLOCKED” are for respectively notifying lock and release of the device according to the command “LOCK-DEVICE” and the command “UNLOCK-DEVICE”. These notifications are sent before sending the responses corresponding to the commands. Since the notifications are sent to all clients, a client that does not request lock of the device knows the lock state of the device by receiving these notifications.

The notification “FAULTED” is for notifying that a fault occurs in the device. A fault number is allocated automatically for the respective faults. The notification “FAULT-CLEARED” is for reporting that the fault is recovered by showing the fault number.

The notification “FAULT-RECOVERY-INSTRUCTION” is sent as a result of acceptance of the command “START-FAULT-RECOVERY” in a case where a fault occurs in the device. In a case where a fault does not occur, the notification “FAULT-RECOVERY-INSTRUCTION” is not sent even when accepting the command “START-FAULT-RECOVERY”. This notification is assumed to be shown to the user since it includes information related to fault recovery performed by the user. For example, when the paper jam occurs in printing, information indicating how to remove the jammed paper is included. According to state of the user's fault recovery, the subsequent notification “FAULT-RECOVERY-INSTRUCTION” is automatically sent if necessary. When a new fault occurs, another notification “FAULT-RECOVERY-INSTRUCTION” is automatically sent until the command “END-FAULT-RECOVERY” is issued. Since the information reported by the notification “FAULT-RECOVERY-INSTRUCTION” indicates fault recovery processes performed by the user, the information includes messages and images or a combination thereof. Multi-language information may have to be taken into account.

The notification “STATUS” is for reporting various statuses (states). The notification “STATUS” is automatically sent when the state is changed. This notification includes a type of object to be notified and a state thereof. A message having name “STATUS” does not exist. The message that has “STATUS” in the tail of its message name is determined to be the notification “STATUS”.

Details of actual message communication methods are not defined here. The actual message communication method may support only communication of the command, the response and the notification, and preferably, the messages are transmitted not in form of binary data but in form of ASCII character code or UTF-8. By using text format data, debugging information is easily obtained in comparison to a case of using binary data. Also, in view of compliance with REST API in actual communication, JSON format is preferable.

Basically, message exchange between the abstract device layer and upper layers is achieved by using a file or shared memory. In a case where a file is designated, the abstract device layer retrieves image data from the file or stores image data in the file. In Linux systems, mmap is expected to be used. An mmap file is transferred to the printer engine or transferred from the scanner engine by using scatter/gather DMA. In a case where the shared memory is used, image data is retrieved from the shared memory whose offset is designated by the command “ATTACH-SHARED-MEMORY”, or image data is written in the shared memory at the designated offset. The abstract device layer does not manage the shared memory. The upper layer is responsible for managing the shared memory.

<Test Using Actual Image Forming Apparatus>

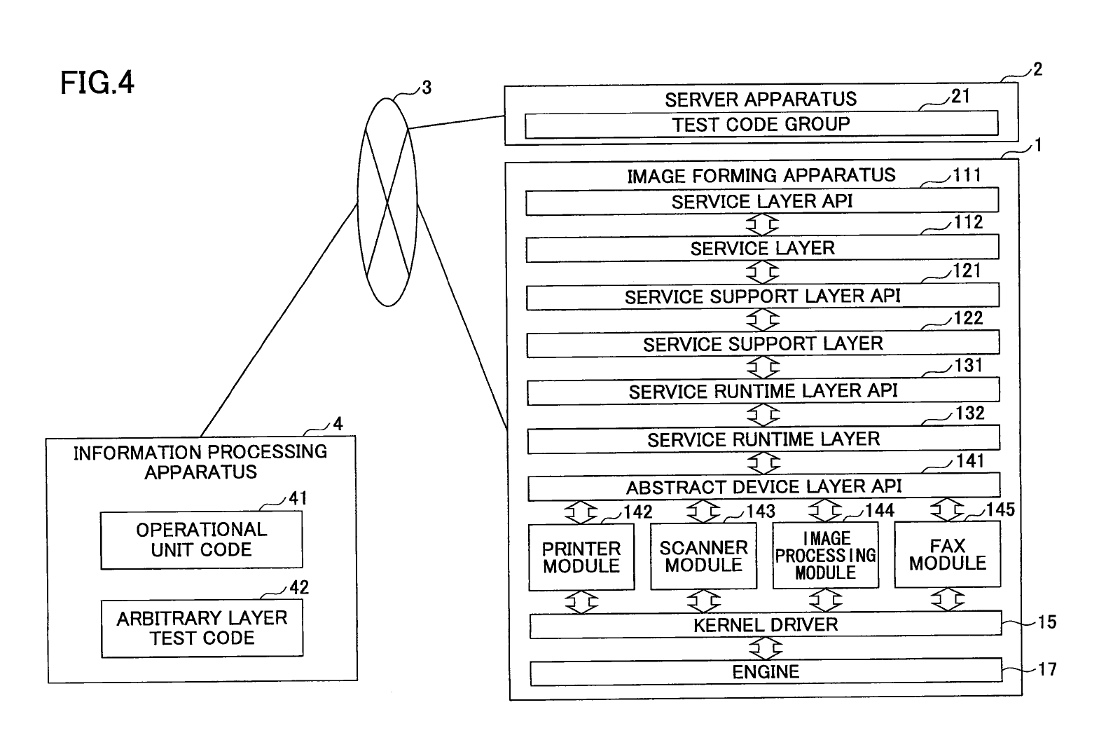

FIG. 4 is a diagram for illustrating an example functional configuration for testing an actual image forming apparatus from an external apparatus. In FIG. 4, the image forming apparatus 1 is connected to the network 3, such as the Internet. A server apparatus 2 and an information processing apparatus 4 such as a PC are also connected to the network 3. Additionally, although the server apparatus 2 can be an information processing apparatus, an apparatus commonly used by users in the network is referred to as the server apparatus 2 while an apparatus used by each user is referred to as the information processing apparatus 4, for convenience of explanation.

Test code group 21 for facilitating the test are stored in the server apparatus 2, which can be referred to by the information processing apparatus 4 and the like. In FIG. 4, the device emulator 162 in the image forming apparatus 1 is omitted since, in general, it is not used in the test using an actual image forming apparatus. An operational unit code 41 and an arbitrary layer test code 42 are stored in the information processing apparatus 4, which are created based on the test code group 21 in the server apparatus 2.

Similar operations to those from an actual operational unit (operational panel) are input in the image forming apparatus 1 by executing the operational unit code 41 by the information processing apparatus 4. Thus, the image forming apparatus 1 becomes to be an image forming apparatus without operational unit. Therefore, tests to check whether processes are normally performed in response to predetermined operational inputs can be conducted on the image forming apparatus 1 having been delivered to a customer.

Also, an arbitrary test can be conducted on an arbitrary layer in the image forming apparatus 1 by executing the arbitrary layer test code 42 by the information processing apparatus 4.

<Test without Actual Image Forming Apparatus>

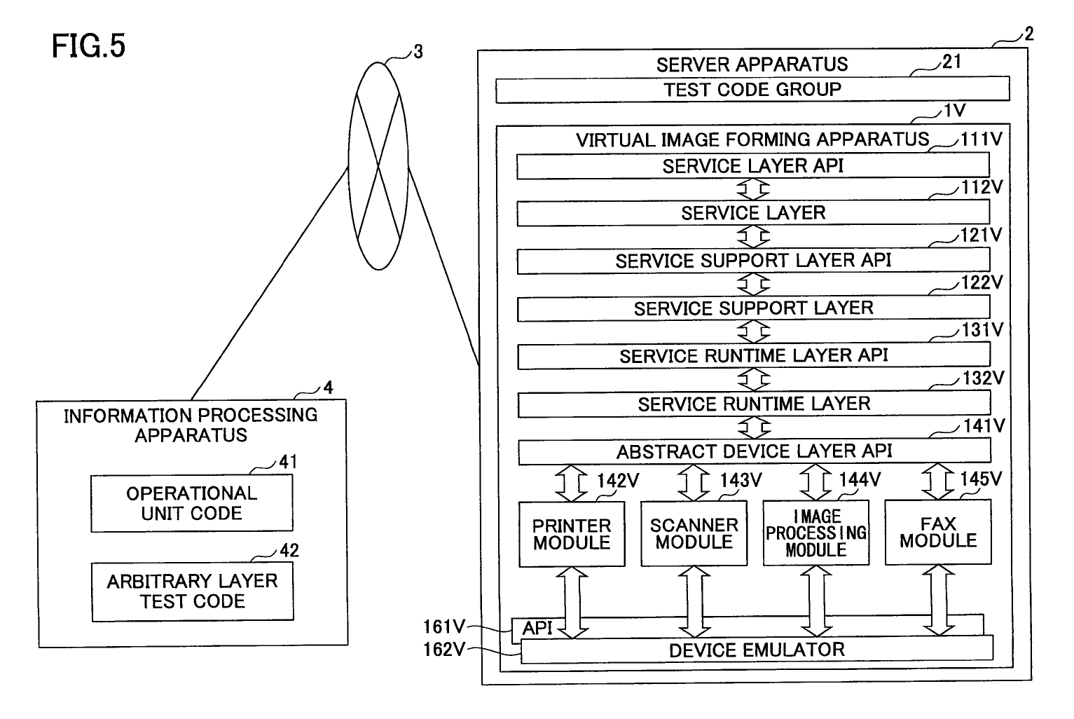

FIG. 5 is a diagram for illustrating an example functional configuration for conducting a test without an actual image forming apparatus. In FIG. 5, the server apparatus 2 and an information processing apparatus 4 such as a PC are connected to the network 3 such as the Internet. Test code group 21 for facilitating the test is stored in the server apparatus 2, which can be referred to by the information processing apparatus 4 and the like. Also, the server apparatus 2 includes a virtual image forming apparatus (virtual machine) 1V which is configured by omitting the engine from the actual apparatus software of the image forming apparatus 1. The virtual image forming apparatus 1V includes a service layer API 111V, a service layer 112V, a service support layer API 121V, a service support layer 122V, a service runtime layer API 131V, a service runtime layer 132V, an abstract device layer API 141V, a printer module 142V, a scanner module 143V, an image processing module 144V, a fax module 145V, an emulator WebAPI 161V and a device emulator 162V. An operational unit code 41 and an arbitrary layer test code 42 are stored in the information processing apparatus 4, which are created based on the test code group 21 in the server apparatus 2.

By executing the operational unit code 41 in the information processing apparatus 4, test operations can be input in the virtual image forming apparatus 1V of the server apparatus 2. Also, by executing the arbitrary layer test code 42 in the information processing apparatus 4, an arbitrary test on an arbitrary layer of the virtual image forming apparatus 1V can be conducted.

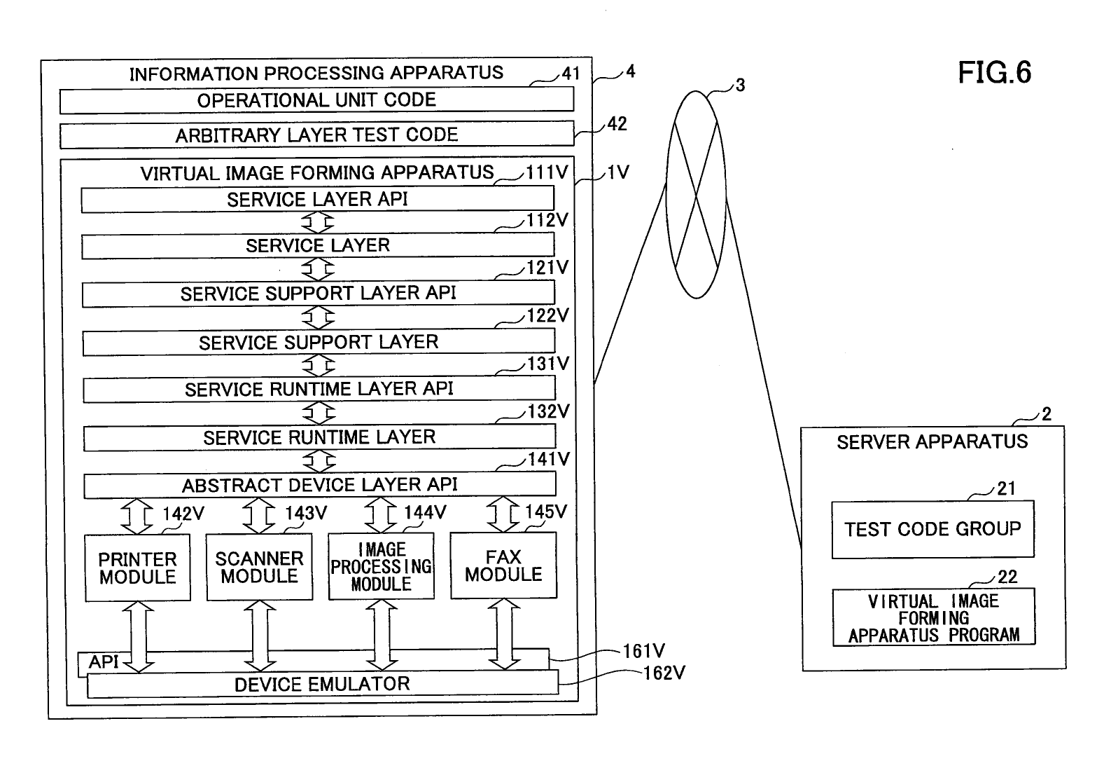

FIG. 6 is a diagram for illustrating another example functional configuration for conducting a test without an actual image forming apparatus. In FIG. 6, the server apparatus 2 and an information processing apparatus 4 such as a PC are connected to the network 3 such as the Internet. Test code group 21 for facilitating the test is stored in the server apparatus 2, which can be referred to by the information processing apparatus 4 and the like. Also, the server apparatus 2 includes a virtual image forming apparatus program 22 downloadable by the information processing apparatus 4, etc., where the virtual image forming apparatus program 22 is configured by omitting the engine from the actual apparatus software of the image forming apparatus 1. In the information processing apparatus 4, there is provided a virtual image forming apparatus 1V which is achieved by executing the downloaded virtual image forming apparatus program 22, where the virtual image forming apparatus 1V includes software omitting the engine from the actual apparatus software of the image forming apparatus 1. The virtual image forming apparatus 1V includes a service layer API 111V, a service layer 112V, a service support layer API 121V, a service support layer 122V, a service runtime layer API 131V, a service runtime layer 132V, an abstract device layer API 141V, a printer module 142V, a scanner module 143V, an image processing module 144V, a fax module 145V, an emulator WebAPI 161V and a device emulator 162V. An operational unit code 41 and an arbitrary layer test code 42 are stored in the information processing apparatus 4, which are created based on the test code group 21 in the server apparatus 2.

By executing the operational unit code 41 in the information processing apparatus 4, test operations can be input in the virtual image forming apparatus 1V of the information processing apparatus 4. Also, by executing the arbitrary layer test code 42 in the information processing apparatus 4, an arbitrary test on an arbitrary layer of the virtual image forming apparatus 1V can be conducted.

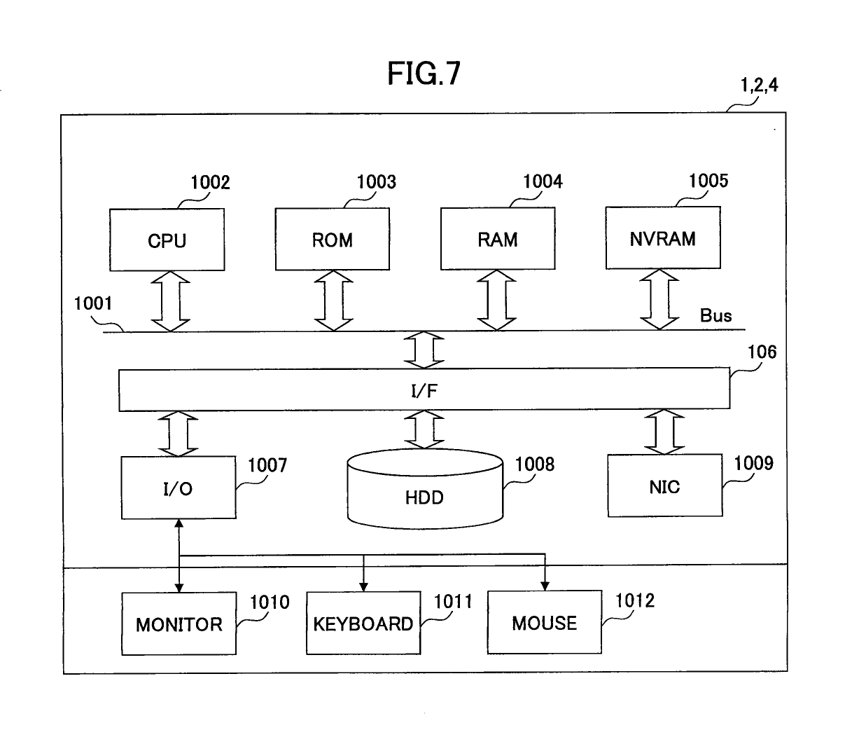

FIG. 7 is a block diagram for illustrating an example configuration of respective computers included in the image forming apparatus 1, the server apparatus 2 and the information processing apparatus 4. In FIG. 7, the computer includes a CPU (Central Processing Unit) 1002, a ROM (Read Only Memory) 1003, a RAM (Random Access Memory) 1004 and a NVRAM (Non-Volatile Random Access Memory) 1005 respectively connected to a system bus 1001. Also, the computer includes an interface (I/F) 1006 and an input/output device (I/O) 1007, a HDD (Hard Disk Drive) 1008 and a NIC (Network Interface Card) 1009 which are respectively connected to the interface 1006, and a monitor 1010, a keyboard 1011 and a mouse 1012 which are respectively connected to the input/output device 1007. A CD/DVD (Compact Disk/Digital Versatile Disk) drive may be connected to the input/output device 1007.

<Device Emulator>

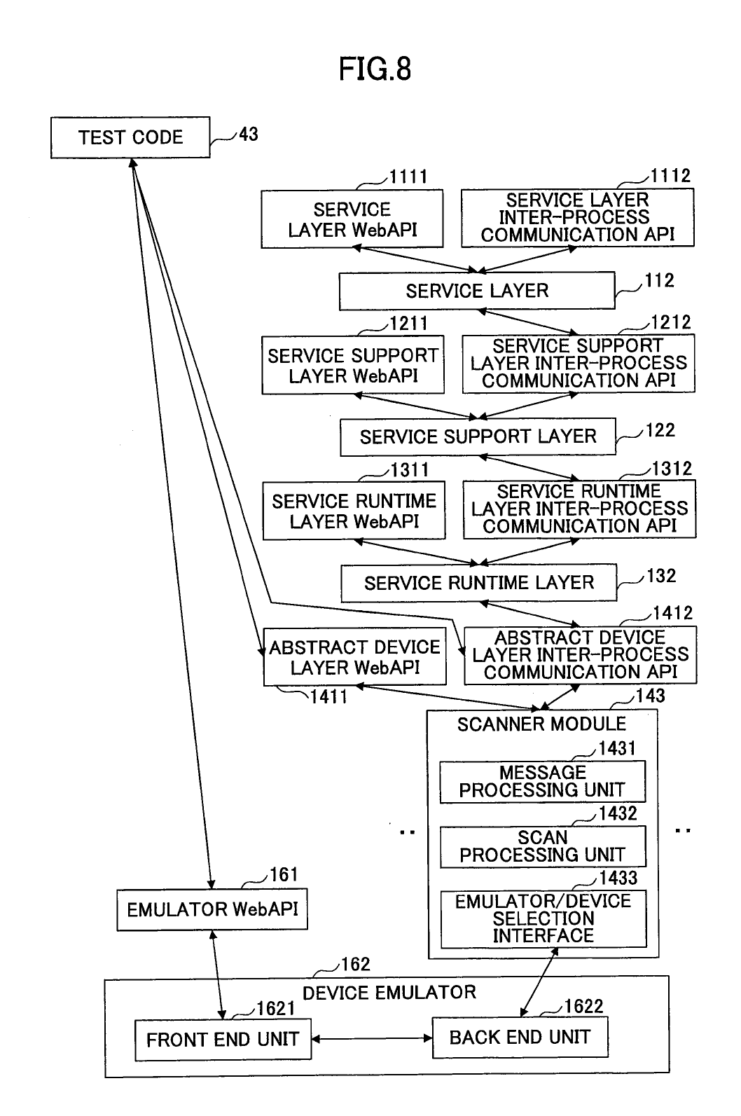

FIG. 8 is a diagram for illustrating an example configuration of the device emulator 162 and an example of connections with other parts. Generally, the configuration shown in FIG. 5 or FIG. 6 is used since little advantage for using the device emulator 162 with an actual image forming apparatus 1 can be found. However, even with the actual image forming apparatus 1, the device emulator 162 may be used in a case where a malfunction occurs in the engine causing the engine to be unavailable, in a case where an engine having different specifications from that of the engine installed in the actual image forming apparatus 1 is to be tested, or the like. Therefore, the device emulator 162 may be used with the actual image forming apparatus as shown in FIG. 4. For convenience of explanation, identical reference numerals will be applied to elements or the like respectively included in the image forming apparatus 1 and the virtual image forming apparatus 1V.

In FIG. 8, the device emulator 162 includes a front end unit 1621 and a back end unit 1622. The front end unit 1621 performs processes on a message sent/received through an emulator WebAPI 161. The front end unit 1621 converts (for example, from REST into internal protocol) the message received from the emulator WebAPI 161 to send it to the back end unit 1622, and converts (for example, from internal protocol into REST) the message received from the back end unit 1622 to send it to the emulator WebAPI 161. The back end unit 1622 has a substantial emulating function in the engine, and is connected with an emulator/device selection interface 1433, etc., of the respective modules (in FIG. 8, only scanner module 143 is shown) in the abstract device layer, and with the front end unit 1621.

Also, in the example shown in FIG. 8, although accessing paths from the test code 43 in the information processing apparatus 4 to an emulator WebAPI 161, to an abstract device layer WebAPI 1411 and to an abstract device layer inter-process communication API 1412 are shown, they are not limiting examples. The accessing path from the test code 43 to the emulator WebAPI 161 is preferable when the test is conducted directly by the device emulator 162 without using other layers. As for only accesses through Web, the accessing paths to the emulator WebAPI 161, to the service layer WebAPI 1111, to the service support layer WebAPI 1211, to the service runtime layer WebAPI 1311 and to the abstract device layer WebAPI 1411 may be used. In an environment where the inter-process communication is available, the accessing paths to service layer inter-process communication API 1112, to the service support layer inter-process communication API 1212, to the service runtime layer inter-process communication API 1312, and to the abstract device layer inter-process communication API 1412 may be used. By using the inter-process communication, quicker accesses can be achieved than those through Web.

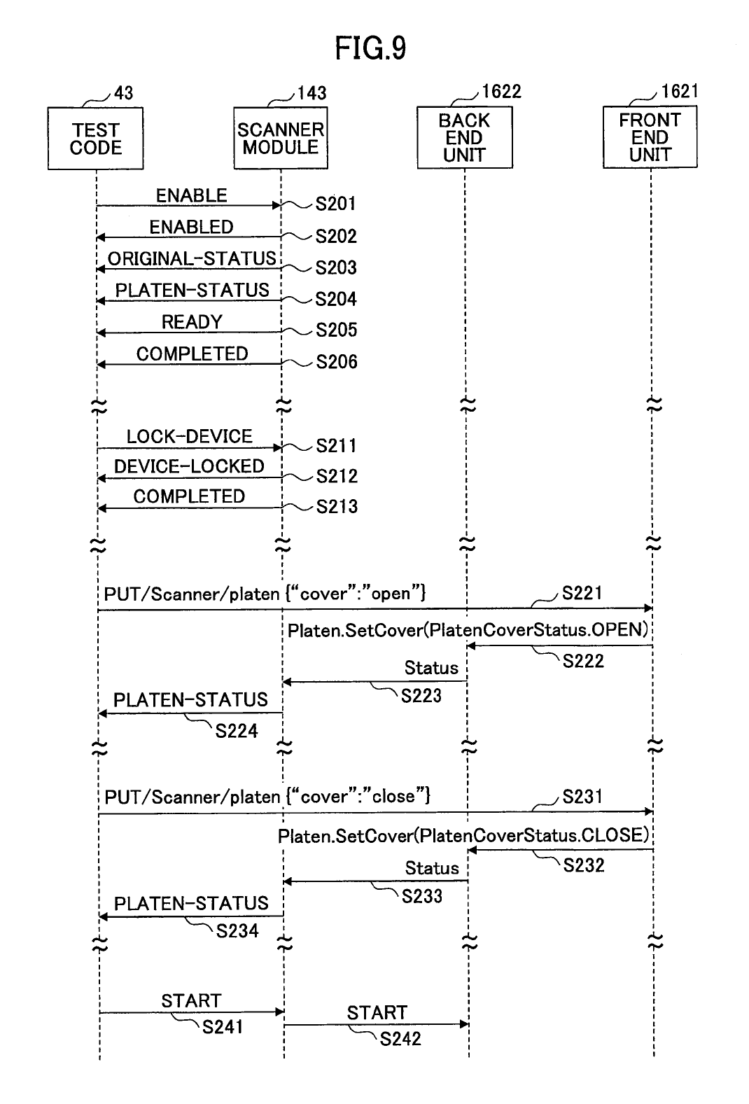

FIG. 9 is a sequence diagram for illustrating an example test. FIG. 9 shows a case where the message is communicated between the test code 43 and the scanner module 143 through the abstract device layer WebAPI 1411 or the abstract device layer inter-process communication API 1412, and a case where the message is sent from the test code 43 to the front end unit 1621 of the device emulator 162 through the emulator WebAPI 161, and sent from the back end unit 1622 to the test code 43 through the scanner module 143 and the abstract device layer WebAPI 1411 or the abstract device layer inter-process communication API 1412.

In FIG. 9, the command “ENABLE” is sent from the test code 43 to the scanner module 143 through the abstract device layer WebAPI 1411 or the abstract device layer inter-process communication API 1412 (step S201). The scanner module 143 sends in sequence the notification “ENABLED”, the notification “ORIGINAL-STATUS”, the notification “PLATEN-STATUS”, the notification “READY”, and the response “COMPLETED” to the test code 43 (steps S202 to S206).

Similarly, the test code 43 sends the command “LOCK-DEVICE” to the scanner module 143 through the abstract device layer WebAPI 1411 or the abstract device layer inter-process communication API 1412 (step S211). The scanner module 143 sends in sequence the notification “DEVICE-LOCKED”, and the response “COMPLETED” to the test code 43 (steps S212 and S213).

Meanwhile, the test code 43 sends the command “PUT/scanner/platen {“cover”: “open”}” to the front end unit 1621 through the emulator WebAPI 161 (step S221). The front end unit 1621 converts it into the internal protocol command “Platen.SetCover(PlatenCoverStatus.OPEN)” to send it to the back end unit 1622 (step S222). The back end unit 1622 performs emulation, and thereby sends the changed status to the scanner module 143 (step S223). The scanner module 143 sends the notification “PLATEN-STATUS” to the test code 43 (step S224).

Similarly, the test code 43 sends the command “PUT/scanner/platen {“cover”: “close”}” to the front end unit 1621 through the emulator WebAPI 161 (step S231). The front end unit 1621 converts it into the internal protocol command “Platen.SetCover(PlatenCoverStatus.CLOSE)” to send it to the back end unit 1622 (step S232). The back end unit 1622 performs emulation, and thereby sends the changed status to the scanner module 143 (step S233). The scanner module 143 sends the notification “PLATEN-STATUS” to the test code 43 (step S234).

Meanwhile, the test code 43 sends the command “START” to the scanner module 143 through the abstract device layer WebAPI 1411 or the abstract device layer inter-process communication API 1412 (step S241). The scanner module 143 sends the command “START” to the back end unit 1622 (step S242). Thus, the emulation for scanning starts.

In the following, communications between the back end unit 1622 of the device emulator 162, and the emulator/device selection interface 1433 of the scanner module 143 (the same in other modules) and the front end unit 1621 will be described with reference to FIG. 8.

The back end unit 1622 has a function for waiting for connection access, as a server, from the emulator/device selection interface 1433 of the scanner module 143 and the front end unit 1621, which serve as clients.

For example, the server waits for the connection access from the client with Unix Domain Socket. For example, the client connects to the server with Unix Domain Socket, wherein the path name of Unix Domain Socket has been set between them.

The server accepts the connection access from only one client at a time, and sends a message “Status” of a connector in an initial state. The client starts the communication after sending a response message to the message “Status” of the connector in the initial state.

The client may terminate the connection with the server at any time. The server may not terminate the connection with the client except a case where an error is detected. The client and the server terminate the connection upon occurrence of a protocol error or an irreparable internal error.

In the message “Status”, character strings of “ready”, “frozen” and “unavailable” can be sent as a connector status. The server can report the message “Status” to the client. The client must process the message in response to receiving the message “Status” and report the same message “Status” to the server. After sending the message “Status”, the server must not send another message “Status” until receiving the response message “Status” to the sent message “Status” from the client. The server must not report the same message “Status” as the message “Status” last receipt from the client.

Byte slice of one command of internal protocol can be sent with the message “Command”. The server can send the message “Command” after receiving the message “ready Status” from the client. After sending the message “frozen Status” or the message “unavailable Status” to the client, the server must not send the message “Command” until receiving the message “ready Status”. The client may send the message “Command” after sending the message “ready Status” to the server. After sending the message “frozen Status” or the message “unavailable Status” to the server, the client must not send the message “Command” until receiving the message “ready Status”.

### SUMMARY

As described above, the present embodiment has advantages as follows.

(1) Since the message processing unit for controlling sequence of the messages input/output in/from the respective layers forming software of the image forming apparatus is disposed, maintenance of the performing sequence or thread safety can be achieved regardless of the OS environment even in a multiprocessor environment, thereby enabling the complex and precise control of computer embedded apparatuses.

(2) The respective layers can provide services by only sending/receiving the messages regardless of location of hardware including the layer, thereby enabling to achieve location transparency.

(3) Since the respective layers hide detailed implementation to provide an interface which is not affected by the detailed implementation, internal configurations can be changed without changing the API.

Therefore, modification of client programs using the API is not required in response to the change of the internal configuration in the respective layers, which enables a significant reduction of workload.

(4) By using the device emulator for emulating an actual device, and other software, a virtual image forming apparatus can be operated in the server apparatus or in the information processing apparatus, thereby enabling the test on an arbitrary layer to be conducted without an actual apparatus.

Thus, the test on the computer embedded apparatus can be flexibly conducted.

(5) Since the test on an arbitrary layer of the actual image forming apparatus can be conducted, tests using the actual apparatuses having been delivered to customers in an actual environment can be conducted.

Thus, the test on the computer embedded apparatus can be flexibly conducted.

(6) Since the lowest layer includes the selection interface for switching the actual device and the device emulator, the same software configuration as in the actual image forming apparatus can be used in the test environment.

(7) Function of an operational unit can be developed separately from function of the image forming apparatus.

Herein above, although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth. The present application is based on Japanese Priority Application No. 2014-145621 filed on Jul. 16, 2014, and Japanese Priority Application No. 2014-145622 filed on Jul. 16, 2014, the entire contents of which are hereby incorporated herein by reference.

What is claimed is:

1. A computer embedded apparatus comprising:
a process control unit configured with a plurality of software layers wherein each of the layers provides a service to an upper layer and each of the layers includes,
a message processing unit configured to control a sequence of messages input to or output from the layer.

2. The computer embedded apparatus as claimed in claim 1, wherein the messages controlled by the message processing unit are divided into three forms that are a command message, a response message that is issued as a response to the command message and a notification message that is issued for conveying an event having occurred in a layer of the layers.

3. The computer embedded apparatus as claimed in claim 2, wherein
the message processing unit includes:
a command processing unit configured to input or output the command message;
a response processing unit configured to input or output the response message;
a notification processing unit configured to input or output the notification message; and
a sequence control unit configured to control the input/output sequence of the command messages, the response messages and the notification messages.

4. The computer embedded apparatus as claimed in claim 3, wherein
the command processing unit inputs the command messages to store the command messages in queues provided for respective types of the command message, whose depths are set according to the respective types, and retrieves the command messages from the respective queues to output them under control of the sequence control unit;
the response processing unit inputs the response messages to store the response messages in queues provided for respective types of the response message, whose depths are set according to the respective types, and retrieves the response messages from the respective queues to output them under control of the sequence control unit;
the notification processing unit inputs the notification messages to store the notification messages in queues provided for respective types of the notification message, whose depths are set according to the respective types, and retrieves the notification messages from the respective queues to output them under control of the sequence control unit; and
the sequence control unit controls the command processing unit, the response processing unit and the notification processing unit to retrieve the command messages, the response messages and the notification messages based on waiting rule information which indicates a waiting rule for defining whether to output the message without waiting for input of another message.

5. The computer embedded apparatus as claimed in claim 1, wherein the respective layers include interfaces for hiding detailed implementation of the respective layers.

6. A non-transitory computer-readable recording medium having stored therein a program for causing a computer included in a computer embedded apparatus to serve as:
a process control unit configured with a plurality of software layers wherein each of the layers provides a service to an upper layer and each of the layers includes a message processing unit configured to control a sequence of messages input to or output from the layer.

7. A computer embedded apparatus test system comprising:
a computer embedded apparatus which includes a process control unit configured with a plurality of software layers wherein each of the layers provides a service to an upper layer;
application program interfaces provided for the respective layers; and
a test conducting unit configured to execute test codes to send/receive signals for conducting tests to/from the respective layers of the process control unit through the application program interface.

8. The computer embedded apparatus test system as claimed in claim 7, wherein the computer embedded apparatus is emulated by a virtual machine installed in an information processing apparatus and configured with the plurality of software layers and the application program interfaces provided for the respective layers, the virtual machine including a device emulator for emulating signal processing of a device included in the computer embedded apparatus and an application program interface provided for the device emulator, and the device emulator providing a service to a layer of the layers.

9. The computer embedded apparatus test system as claimed in claim 8, wherein the device emulator provides the service to a lowest layer in the layers, and the lowest layer includes a selection unit for switching connections to the device and to the device emulator.

10. The computer embedded apparatus as claimed in claim 8, wherein the device emulator includes:
a front end unit configured to input/output a message through the application program interface; and
a back end unit configured to input/output a message to/from the lowest layer of the layers through the application program interface, input/output a message to/from the front end unit, and emulate the signal processing of the device.
